(19) United States
(12) Patent Application Publication
(10) Pub. No.: US 2005/0181201 A1
(43) Pub. Date: Aug. 18, 2005

(54) Release film

(76) Inventors: Masahi Tate, Sakata-gun (JP); Osamu Nishizawa, Yokkaichi-shi (JP); Maki Kunitake, Yokkaichi-shi (JP); Motohiro Seki, Yokkaichi-shi (JP)

Correspondence Address: EDWARDS & ANGELL, LLP, P.O. BOX 55874, BOSTON, MA, 02205, US

(21) Appl. No.: 10/502,718

(22) PCT Filed: Jan. 17, 2003
(86) PCT No.: PCT/JP03/00347

(30) Foreign Application Priority Data
Jan. 30, 2002 (JP) 2002-21379
Mar. 15, 2002 (JP) 2002-72349
Apr. 3, 2002 (JP) 2002-101062

(51) Int. Cl. B32B 5/16

(52) U.S. Cl. 428/331; 428/480

(57) ABSTRACT

A release film having a release layer on at least one surface of a base film, the proportion of silicon atoms to carbon atoms (Si/C) in the surface of said release layer being not more than 0.01, the proportion of halogen atoms to carbon atoms (X/C) being not more than 0.1, the peel force of said release film being not more than 75 mN/cm, and the retained adhesion rate of said release film being not less than 80%. This release film contains substantially no silicon and halogen elements and is of the easy release type.

### TECHNICAL FIELD

The present invention relates to a release film. More particularly, it relates to a release film which can be used favorably in the production processes of electronic parts, etc.

### BACKGROUND ART

Release film has been used widely as a protection of the adhesive or bonded surfaces. Silicone-based polymers containing siloxane units are the most popularly used as the material comprising the releasable side of the release film. The siloxane-based release agents, however, contain siloxane type low-molecular weight substances which tend to be vaporized and oxidized in the art, so that when they are applied to precision uses such as manufacture of electronic parts, there could arise the trouble of adhesion of the oxides of the siloxane type low-molecular weight substances. Therefore, a film free from any siloxane source and still having releasability equal to the silicone-based release films has been demanded.

As a release agent suited for the uses mentioned above, those reduced in surface energy by a halogen compound such as a fluoride have been proposed. For instance, the patent applications such as Japanese Patent Application Laid-Open (KOKAI) Nos. 55-165925, 1-198349, 4-246532, 4-270649, 4-290746, 2001-129940, 2001-138338, 2000-263714 and 2001-129940 can be cited. However, these release agents are mostly of difficult release type as compared to the presently used silicone-based agents and also do not necessarily conform to the recent trend toward dehalogenization for reducing environmental load in waste disposal.

Polyolefins or long-chain alkyl-containing polymers are known as the release agents containing neither silicon nor halogen elements. For example, the patent applications such as Japanese Patent Application Laid-Open (KOKAI) Nos. 54-7442, 55-69675, 5-329994, 10-183078, 11-28708 and 2000-303019 can be cited. These release agents, however, are all of difficult release type, with the peel force of the release film exceeding 100 mN/cm, so that the uses to which they can be applied are limited. Further, since solvent resistance is not required in the conventional primary uses of the long-chain alkyl-containing polymers, they have the problem that they are not suited for the films used in the step of casting a solution or slurry.

### DISCLOSURE OF THE INVENTION

As a result of the present inventors' earnest studies to be solve the above problem, it has been found that by using a long-chain alkyl-based polymer obtained from a specific formulation, it is possible to constitute an excellent release layer substantially free of silicon and halogen elements. The present invention has been attained on the basis of the above finding.

Thus, in an aspect of the present invention, there is provided a release film having a release layer on at least one surface of a base film,
the proportion of silicon atoms to carbon atoms (Si/C) in the surface of said release layer being not more than 0.01,
the proportion of halogen atoms to carbon atoms (X/C) being not more than 0.1,
the peel force of said release film being not more than 75 mN/cm, and
the retained adhesion rate of said release film being not less than 80%.

The present invention is described in detail. The “base film” referred to in the present invention is a sheet-like molded product comprising a single or plural layers comprising a polymer properly selected from polyesters, polyolefins, polyamides and the like. Thickness of the base film is usually 10 to 250 μm.

As the polymer used for the base film, polyesters, especially polyethylene terephthalate, polyethylene-2,6-naphthalate and their derivatives are preferred from the viewpoint of heat resistance and strength. The base film can be obtained by the conventional methods such as extrusion molding, casting, etc., but from the viewpoint of heat resistance, it is preferable to form a sheet, as required, to stretch and heat-set the molded sheet. In the base film, various types of stabilizer, ultraviolet absorber, lubricant, pigment, antioxidant and plasticizer may be added.

As the polyester used for the base film, in case where the film is used for the applications where ionic impurities are to be avoided, such as the film used in the production process of semiconductor parts, it is preferable to use as a polymerization catalyst a germanium compound and/or a titanium compound which have been found to be very low in the degree of damage they might cause against the normal function of the semiconductor devices. As the germanium compound and titanium compound used as a polymerization catalyst in this case, oxides, inorganic acid salts, organic acid salts, halides, sulfides and the like can be cited, but especially germanium dioxide (or its derivatives) or tetrabutyl titanate (or its derivatives) is preferably used. The amount of the polymerization catalyst used, counted as the amount of germanium element and/or titanium element remaining in the polyester, is usually 1 to 200 ppm, preferably 1 to 150 ppm, more preferably 1 to 90 ppm. When a germanium compound alone is used, its lower threshold value is usually 10 ppm, preferably 20 ppm, more preferably 25 ppm. When a titanium compound alone is used, its upper threshold value is usually 30 ppm, preferably 20 ppm, more preferably 10 ppm. When the amount of the catalyst used is less than 1 ppm, the polymerization reaction does not proceed smoothly, and when it exceeds 200 ppm, it is unsuited for use in the present invention.

In case of using a polyester for the base film, it is preferable to blend silicon dioxide in the polyester as needed in view of slip characteristics of the produced film. In this case, the particle size of silicon dioxide is selected from the range of usually 0.001 to 5 μm, preferably 0.01 to 3 μm, while its amount blended in the polyester is selected from the range of usually 0.01 to 2% by weight, preferably 0.02 to 0.5% by weight. When the particle size and content of silicon dioxide are below the above-defined ranges, slip characteristics of the produced film are not improved, and when they exceed the above-defined ranges, they are found unfit for use in the present invention. In the present invention, it is possible to use, for instance, crosslinked polymer particles as the organic lubricant component in place of silicon dioxide. The lower limits of the size and the amount blended of the crosslinked polymer particles can be decided in the same way as described above, but the upper limit of the amount blended is not specifically defined.

The base film of the present invention preferably contains substantially no metal compounds other than germanium, titanium and silicon compounds. That is, in the present invention, it is preferable substantially not to use ester exchange reaction catalysts represented by alkaline metal compounds and alkaline earth metal compounds and the additives that may become an inducement to ionic impurities (e.g. calcium carbonate, barium carbonate, kaolin, talc and zeolite). The total amount of the metal compounds other than germanium, titanium and silicon compounds, calculated as metal elements, should be usually not more than 30 ppm, preferably not more than 10 ppm, more preferably not more than 5 ppm, based on the polyester. If necessary, a phosphorus (P) compound may be contained. The phosphorus compounds have generally the effect of inactivating the metal compounds and improving thermal stability of polyesters. In some cases, a good result can be obtained when a phosphorus compound is allowed to exist in the polyester in an amount of about 5 to 200 ppm as P element. It is however preferable that its amount be confined to the minimum, specifically 5 to 50 ppm.

The “release layer” referred to in the present invention is a surface layer having releasability provided on at least one side of the base film. In case where the base film has been coated with a polymer having releasability, it (release layer) indicates the polymer coat.

In the release layer of the present invention, the proportion of silicon atoms to carbon atoms (Si/C) in the release layer surface must be not more than 0.01. Si/C is preferably not more than 0.001, and most preferably the release layer surface is substantially free of silicon atoms. If Si/C exceeds 0.01, in practical use of the release film, silicon may be transferred onto the surface of the object to be protected, such as adhesive surface, or into the outer environment to become an acute cause of contamination.

In the release layer of the present invention, the proportion of halogen atoms to carbon atoms (X/C) in the release layer surface should be not more than 0.1. Here, halogen atoms (X) refer to fluorine, chlorine, bromine, etc. X/C is preferably not more than 0.01, and most preferably the release layer surface is substantially free of halogen atoms. X/C in excess of 0.1 is not preferable from the viewpoint of reduction of environmental load.

The silicon density and halogen element density in the release layer may be made substantially zero by making substantially zero the silicon density and halogen element density in the coating material before it is applied to the base film.

In the release film of the present invention, the peel force at the release surface is not more than 75 mN/cm, preferably not more than 50 mN/cm, more preferably not more than 40 mN/cm. When the peel force is more than 75 mN/cm, the film is not suited for uses where easy release is required. The lower threshold of peel force is usually 5 mN/cm.

In the release film of the present invention, the retained adhesion rate is not less than 80%, preferably not less than 90%. A retained adhesion rate of less than 80% is not preferable because the amount of transfer of the release layer material to the adherend increases.

In the release film of the present invention, the ratio of the peel force before dipping in toluene to the peel force after dipping in toluene, namely peel force retention after dipping in toluene is usually not less than 80%, preferably not less than 90%, more preferably not less than 95%. If peel force retention after dipping in toluene is not less than 80%, the film shows excellent solvent resistance.

As a compound used for the release agent which substantially contains neither silicon nor halogen elements and which can realize, when made into a release film, a peel force of not more than 75 mN/cm (easy release), a retained adhesion rate of not less than 80% and a peel force retention after toluene dipping of not less than 80%, there can be cited, for instance, a combination of a polymer having long-chain alkyl side chains on the polymethylene backbone and comprising copolymerized units having reactive functional groups, and a crosslinking agent which provides crosslinkage between the said reactive functional groups.

As the polymers having long-chain alkyl side chains on the polymethylene backbone, polyalkyl(meth)acrylate, polyvinylalkylcarbamate, polyalkylmaleimide, etc., can be cited. Here, as the alkyl groups, there can be cited long-chain alkyl groups having 12 to 22 carbon atoms such as lauryl group, stearyl group and behenyl group. Preferably each polymer has plural different types of long-chain alkyl side chain.

As the said reactive functional groups, hydroxyl group, isocyanate group, etc., can be cited for instance, and as examples of the copolymer units having hydroxyl groups, vinyl alcohol, 2-hydroxyethyl methacrylate, etc., can be cited. Too many reactive functional groups become a factor of providing difficult release, while too few reactive functional groups make peel force retention unsatisfactory, so that the copolymerization ratio of the units having reactive functional groups is usually around 0.5 to 20 mol %. In case of using hydroxyl groups as reactive functional groups, it is possible to use a polyfunctional isocyanate compound as crosslinking agent.

The functional isocyanate compounds are the blocked or non-blocked polyisocyanate compounds having isocyanate groups, which include, for instance, aliphatic chain polyisocyanate compounds such as hexamethylene diisocyanate and trimethylhexamethylene diisocyanate, alicyclic polyisocyanates such as hydrogenated diphenylmethane diisocyanate and isophorone diisocyanate, compounds having terminal isocyanate obtained by reacting low-molecular active hydrogen-containing compounds such as glycerin, trimethylolpropane and hexanetriol with an excess amount of the said polyisocyanate compounds, polymers of these polyisocyanate compounds, and polyisocyanate compounds obtained by blocking the said non-blocked polyisocyanate compounds with an isocyanate blocking agent. In the present invention, the aliphatic polyisocyanate compounds having three or more isocyanate groups are preferred from the viewpoint of solvent resistance.

As the polyfunctional isocyanate compounds, those commercially available such as “Mytech NY710A” (76 wt % ethyl acetate solution of an aliphatic diisocyanate/triol adduct (trifunctional diisocyanate)) produced by Mitsubishi Chemical Corporation “Mytech NY718A” (76 wt % butyl acetate solution of aliphatic diisocyanate/triol adduct (trifunctional isocyanate)) produced by Mitsubishi Chemical Corporation and “Mytech NYT36” (47 wt % toluene/methyl ethyl ketone/ethyl acetate (1/1/0.3 by weight) mixed solvent solution of a modified aliphatic polyisocyanate compound (tetrafunctional isocyanate)) produced by Mitsubishi Chemical Corporation are preferred.

Conversely, in case of using a compound having isocyanate-terminated reactive functional groups, it is possible to use polyhydric alcohols or the like as crosslinking agent.

In the compound forming the release layer, there may be added, as required, defoaming agent, coating properties improver, thickener,-surfactant, lubricant, organic particles, inorganic particles, antioxidant, ultraviolet absorber, dye, pigment, high-molecular compounds, crosslinking agent, etc.

The release layer is formed by applying a solution of a release agent on a base film, conducting a heat treatment thereon, then drying and heat-curing the coat. The release layer obtained in this manner can satisfy simultaneously the requests for easy release, high peel force retention and high retained adhesion rate.

The release layer may be formed either on one side alone or on both sides of the base film. In case where it is formed on one side alone, a layer such as easy slip layer or antistatic layer may be formed on the opposite side as required. Also, an intermediate layer such as easy adhesion layer or antistatic layer may be provided between the base film and the release layer. Further, if necessary, the base film surface may be subjected to an easy adhesion treatment such as corona discharge treatment.

The release layer thickness is usually not less than 10 nm, preferably not less than 50 nm. When the release layer thickness is less than 10 nm, releasability of the layer may deteriorate because a uniform layer is hardly obtainable. On the other hand, the upper limit of the release layer thickness is not specifically defined, but it is preferably not more than 10 μm for the reason that too thick release layer is caused to an increase of cost, and in some cases, slip characteristics are deteriorated when the layer thickness is more than 10 μm.

As the method of forming a release layer on the surface of a base film, for instance hot melt method, coating and co-extrusion method can be mentioned. In the case of coating, there can be cited a method in which a coating solution is applied outside the base film production process and a method in which the coating solution is applied in the film production process, by using a coating means such as reverse coater, gravure coater, rod coater and air doctor coater shown in Yuji Harasaki: Coating System, Maki Shoten, 1979, or other types of coating devices.

As one of the fields of application of the release film of the present invention, its use in forming green sheets can be cited. In such uses, in view of slurry coating defects such as cissing and skips of coating, the surface center plane average roughness SRa of the release layer is usually not more than 20 nm, preferably not more than 10 nm. Further, when the release layer surface is of such a structure, SRa of the opposite side is preferably 10 to 50 nm. When SRa of the opposite side is less than 10 nm, there is a fear of blocking taking place, and when it exceeds 50 nm, there is a possibility of causing transfer of surface protuberances to the release layer surface.

### BEST MODE FOR CARRYING OUT THE INVENTION

In the following, the present invention is described in further detail with reference to the examples thereof, but the present invention is not limited to these examples but can be embodied otherwise without departing from the scope and spirit of the invention.

(1) Atomic Proportions in the Surface

The atomic proportions in the release layer surface are given by halogen atom concentration/carbon atom concentration, and silicon atom concentration/carbon atom concentration, from the atomic species existing in the surface and atomic concentrations determined by X-ray photoelectric spectroscopy. Using the Ka rays of Mg obtained by using “ESCA-1000” of Shimadzu Corporation under the conditions of 8 kV and 300 mA, the spectra originating from C(1S), Si(2S), Cl(2P), F(1S) and Br(3d) were determined, and their peak areas were corrected by using the following atomic sensitivity factors to estimate the atomic concentrations in the layer surface. Then, by referring to the concentration derived from C(1S), the concentrations of the respective atoms were normalized to determine silicon atom proportion (Si/C), chlorine atom proportion (Cl/C), fluorine atom proportion (F/C) and bromine atom proportion (Br/C). The atomic sensitivity factors are as follows:
C(1S)=1.0, Si(2S)=0.86, Cl(2P)=2.36, F(1S)=4.26, Br(3d)=3.04.
   (2) Peel Force [mN/cm]

An adhesive tape “No 502” (produced by Nitto Denko Corporation) was pasted on the release layer surface, and after left at room temperature for one hour, it was peeled through 180° by pulling it at a rate of 300 mm/min by a tensile tester. The average peel load in the region where peel was stabilized was divided by the width of the adhesive tape, and the quotient was expressed as peel force.

(3) Retained Adhesion Rate [%]

An adhesive tape “No. 31B” (produced by Nitto Denko Corporation) was attached fast on the release layer surface by having a 2 kg rubber roll make one back and forth movement on the release layer, and then heat treated at 100° C. for one hour. Then the attached release film was peeled, and using the adhesive tape “No. 31B”, the adhesive force F was measured according to JIS-C-2107 (adhesive force against a stainless steel plate, measured by 1800 peel method). The percentage of F to the adhesive force FO observed when the adhesive tape “No. 31B” was directly attached to and peeled off from the stainless steel plate was expressed as retained adhesion rate.

(4) Peel Force Retention [%] after Dipping in Toluene

A film was dipped in toluene for 3 minutes at room temperature and under atmospheric pressure, then taken out and air dried. An adhesive tape “No. 502” was pasted to the release layer surface of this film, and after left at room temperature for one hour, the tape was peeled through 180° by pulling it at a rate of 300 mm/min by a tensile tester. The average peel load in the region where peel was stabilized was divided by the width of the adhesive tape, and the quotient was expressed as peel force F. The percentage of the peel force f observed when no dipping in toluene was conducted to F was expressed as peel force retention after dipping in toluene.

(5) Ionic Impurity Substitute Evaluation Method

An acrylic adhesive was applied on the surface of the release layer of a release film and dried at 1000 for 5 minutes to form a 20 μm thick adhesive layer. Then a 50 μm thick biaxially oriented polyester film was press bonded on the adhesive layer to obtain an adhesive tape.

Then, on a silicon substrate, after having its surface oxidized by a conventional method, electrodes were formed by photoresist method to make a plurality of Zener diodes. The release film of the said adhesive tape was peeled and placed on the resist surface on the silicon substrate having the adhesive layer, and the resist was peeled. Scatter of Zener voltage between the elements in the thus obtained substrate was measured, and when its deviation from the standard Zener voltage was less than 2.0%, it was judged that the ionic impurities are small in quantity.

(6) Release Layer Thickness [nm]

The absolute reflectance by 5° specular reflection of the release film was measured, and the wavelength λ [nm] at which the reflectance was minimized was determined. Separately from this, the polymer composing the release layer was cast and solidified on a glass plate, and its refractive index n at 589 nm was determined, calculating the release layer thickness λ [nm] from the following equation:
d=0.25 λ/n
(Polymerization of Polyesters)
Polyester A:

86 parts of terephthalic acid and 70 parts of ethylene glycol were supplied into a reactor and subjected to a 4-hour esterification reaction at about 250° C. Then 0.012 part of germanium dioxide, 0.1 part of silicon dioxide (wet process) having an average particle size of 1.5 μm and 0.01 part of phosphoric acid (32 ppm as P element based on the polymer) were added, and the mixture was gradually heated from 250 to 285° C. while reducing the pressure gradually till reaching 0.5 mmHg. 4 hours later, the polymerization reaction was stopped to obtain a polyester A having an intrinsic viscosity of 0.65. The concentrations of germanium and phosphorus element in the polyester A based on the polymer were 45 ppm and 25 ppm, respectively.

Polyester B:

Polyester B was obtained in the same way as polyester A except that 0.03 part of antimony trioxide was used in place of germanium dioxide. The concentrations of antimony element and phosphorus element in the polyester B based on the polymer were 245 ppm and 27 ppm, respectively.

(Production of Polyester Film)

Polyester pellets were melted by a double-screw extruder, extruded onto a cast drum from a T-die and rapidly cooled to lower than the glass transition point to obtain a substantially amorphous sheet. The obtained amorphous sheet was stretched 3.5 times in the machine direction at 80° C. by a roll stretcher and then further stretched 4.0 times transversely at 100° C. by a tenter stretcher. Successively the sheet was heat set at 230° C. for 2 seconds with its width remained unchanged, and then relaxed 5% in the width direction at 160° C. to obtain a 38 μm thick polyester film.

(Preparation of Release Layer Coating Compositions)

Coating Solution A:

33.5 g (99 mmol) of stearyl methacrylate, 0.13 g (1 mmol) of hydroxyethyl methacrylate and 35 g of toluene were supplied into a flask equipped with a nitrogen-replaced condenser, a nitrogen introducing pipe, a stirrer and a thermometer, and nitrogen was bubbled through the solution for 15 minutes. To this, 164 mg (1 mmol) of azobisisobutyronitrile was added, and the mixture was polymerized at 75° C. for 5 hours. At this stage, when measured by GPC with polystyrene calibration, the product was found to have a number-average molecular weight of 49,050, and its molecular weight distribution was 2.93. After the completion of the polymerization, the product was reprecipitated in 500 ml of acetone to obtain 29.5 g of a polymer.

1 g of this polymer and 11.0 mg of “Mytech 718A”, a 76 wt % butyl acetate solution of an aliphatic isocyanate/triol adduct (trifunctional isocyanate) produced by Mitsubishi Chemical Corporation were dissolved in 99.0 g of toluene to prepare a coating solution.

Coating Solution B:

A coating solution was prepared in the same way as coating solution A except that a mixture of 30.1 g of stearyl methacrylate and 2.51 g of lauryl methacrylate was used in place of 33.5 g of stearyl methacrylate.

Coating Solution C:

A coating solution with a 1 wt % concentration was prepared in the same way as coating solution A except that a butyl acetate solution of “Mytech 18A” was not mixed.

Coating Solution D:

14.1 g of a hexafunctional acrylic monomer dipentaerythritol hexaacrylate, 5.9 g of stearyl acrylate and 0.6 g of 1-hydroxycyclohexyl phenyl ketone (photopolymerization initiator) were dissolved homogeneously in 1,980 g of toluene to prepare a coating solution.

### EXAMPLE 1

Coating solution A was applied on a polyester film made of polyester A by a Mayer bar so that the coating would have a wet thickness of 12 μm, and then heat treated at 120° C. for 2 minutes to obtain a release film.

### EXAMPLE 2

A release film was obtained in the same way as Example 1 except that coating solution A was replaced by coating solution B.

### EXAMPLE 3

A release film was obtained in the same way as Example 1 except that coating solution A was replaced by coating solution C.

### EXAMPLE 4

A release film was obtained in the same way as Example 1 except that the base film was replaced by a polyester film made of polyester B.

### COMPARATIVE EXAMPLE 1

Coating solution D was applied on a polyester film by a Mayer bar so that the coating would have a wet thickness of 12 μm, and then dried at 120° C. for 2 minutes, after which ultraviolet rays of 1,000 mJ/cm² was applied at room temperature to cure the release layer to obtain a release film.

TABLE 1

| | | | | |
|---|---|---|---|---|
| Type of | | | | |
| polyester | Si/C | F/C | Cl/C | Br/C |

| | | | | | |
|---|---|---|---|---|---|
| Ex. 1 | A | 0 | 0 | 0 | 0 |
| Ex. 2 | A | 0 | 0 | 0 | 0 |
| Ex. 3 | A | 0 | 0 | 0 | 0 |
| Ex. 4 | B | 0 | 0 | 0 | 0 |
| Comp. Ex. 1 | A | 0 | 0 | 0 | 0 |

TABLE 2

| | | | | | Comp. |
|---|---|---|---|---|---|
| | Ex. 1 | Ex. 2 | Ex. 3 | Ex. 4 | Ex. 1 |
| Peel force (mN/cm) | 71 | 39 | 70 | 71 | 690 |
| Retained adhesive | 99 | 100 | 99 | 99 | 99 |
| force (%) | | | | | |
| Peel force retention | 97 | 98 | 34 | 98 | 96 |
| after dipping in | | | | | |
| toluene (%) | | | | | |
| Ionic impurities | Few | Few | Few | Many | Few |
| Release layer (nm) | 105 | 105 | 105 | 105 | 105 |

### INDUSTRIAL APPLICABILITY

The release film of the present invention is suited for the uses where the absence of siloxanes is required, and the uses such as surface protection of silicone rubber molding process films and silicone-based adhesives.

1. A release film having a release layer on at least one surface of a base film,
the proportion of silicon atoms to carbon atoms (Si/C) in the surface of said release layer being not more than 0.01,
the proportion of halogen atoms to carbon atoms (x/c) being not more than 0.1,
the peel force of said release film being not more than 75 mN/cm, and
the retained adhesion rate of said release film being not less than 80%:

2. A release film according to claim 1, wherein the peel force retention after dipping in toluene is not less than 80%.

3. A release film according to claim 1 or 2, wherein the base film comprises a polyester film which contains 1 to 200 ppm of germanium element and/or titanium element and, if necessary, 0.01 to 2% by weight of silicon dioxide particles having an average size of 0.001 to 5 μm, and which contains substantially no other metal components.
